(19) United States
(12) Patent Application Publication
(10) Pub. No.: US 2006/0282816 A1
(43) Pub. Date: Dec. 14, 2006

(54) OBJECT-ORIENTED MEETING PROCESS MODEL FOR SOFTWARE DEVELOPMENT MANAGEMENT

(75) Inventor: Chung-Yang Chen, Kwei-Shan (TW)

Correspondence Address: NIKOLAI & MERSEREAU, P.A., 900 SECOND AVENUE SOUTH, SUITE 820, MINNEAPOLIS, MN, 55402, US

(73) Assignee: CHANG GUNG UNIVERSITY, Kwei-Shan (TW)

(21) Appl. No.: 11/160,075

(22) Filed: Jun. 8, 2005

(51) Int. Cl. G06F 9/44

(52) U.S. Cl. 717/101

(57) ABSTRACT

One of the most difficult things about project management is unknown ongoing condition, status, and quality during process. Existing project management methods and software tools present a discrete way to manage project development. This invention proposes an object-based, meeting-oriented methodology in order to manage project development more continuously. Said invention includes three main parts: (1) using object technology to model and define a generic meeting operation and specialize meeting classes that are required for software project development, (2) develop a meeting oriented process that composing of a list of meeting objects for per project development, (3) tailoring guidelines for customizing meeting process model to ad-hoc projects.

### BACKGROUND OF THE INVENTION

1. Field of the Invention

The present invention relates to an object-oriented meeting process model for software development management, and more particularly to an improved model which utilizes object-oriented technology to manage software projects and their development process during meetings, and work out the flow charts and data flow diagrams by defining the meetings and derivative meeting types.

2. Description of Related Art

At present, most of project management tools commercially available, e.g. Project Console from Rational product suite, MS Project, WindChill, Primavera, Timeline, Work Bench, Project Scheduler, and Agile, are computer-aided project planning devices.

However, some project management tools for flow process management only offer WBS (Work breakdown Structure) and related schedule control capability while establishing the checkpoints. And, related system will inform relevant key personnel to submit their outputs at the moment of deadline. Yet, these conventional software management methods or tools are focused on timing, budgeting and resource planning, which belong to sectional or one-sided management. Thus, the implementation plans are inaccessible or only accessible to a few people, or the progress and quality can only be identified from checkpoints. Though some project management tools allow for key personnel of different authorities to access the project outputs via Internet (e.g. Project Console in Rational Suite), it is difficult to prevent gross negligence, especially when the project managers cannot supervise the detailed progress;

To this end, the existing project management tools lack of a method for sustainable management and monitoring of project development process and flow process.

Thus, to overcome the aforementioned problems of the prior art, the inventor has strived to find out solutions and finally provided an object-oriented meeting process model for software development management after numerous tests and improvements based on his years of experience in the production, development and design of related products.

### SUMMARY OF THE INVENTION

For this reason, the first objective of present invention is to provide an object-oriented meeting process model for software development management, which can inform relevant key personnel of necessary information of meetings.

Moreover, another objective of present invention is to provide an object-oriented meeting process model for software development management, which can place a restriction on inputs of key personnel based on meeting review and evaluation.

Also, the third objective of present invention is to provide an object-oriented meeting process model for software development management, which can provide a guideline for work outputs through meetings and continuous meeting requirements.

Furthermore, the fourth objective of present invention is to provide an object-oriented meeting process model for software development management, which makes you be aware of project progress and phases for continuous software management according to meetings or otherwise (namely achieving the meeting objectives).

For above-specified purposes, the present invention is directed to an object-oriented meeting process model for software development management, which, via the help of analysis/design method of object-oriented system, depicts the meeting framework by defining meeting types, properties, state of objects and meeting behavior. And, it can present a description of the interaction of jobs or meetings and of how to deliver and handle the meeting document flow based on the meeting flow process of project management.

Of which, the meeting process model is used to improve the transparency of project management and strengthen information combination for an integrated project development.

Of which, some common teleconference technologies may be incorporated into actual meetings against geographical constraints.

In case where some smaller projects or trivial tasks for a meeting have not yet been completed, the meeting presider is not required to convene another meeting at his discretion. In such case, the meeting is still “under progress”. To prevent hasty conclusion of meetings, the meeting presider shall submit the meeting results for examination and approval prior to turning the meeting state into “accomplished”.

During definition of meetings, the drafters, authorities to access and modify, etc, are used for modeling the relations between documents and relevant key personnel. And, when the convener is ready to hold a meeting, a meeting object may occur and then the meeting is “under preparation”. The system will provide a display for real-time modification of the access authority of key personnel.

The defined meetings are held based on general flow process. Still, the present invention has established a flow optimization principle for project optimization purpose by means of meeting combination.

The present invention shall be applied in accordance with other flow criteria and standards, such as capability maturity integration model (CMMI).

The other features and advantages of the present invention will be more readily understood upon a thoughtful deliberation of the following detailed description of a preferred embodiment of the present invention with reference to the accompanying drawings and icons. However, it should be appreciated that the present invention is capable of a variety of embodiments and various modifications by those skilled in the art, and all such variations or changes shall be embraced within the scope of the following claims.

### BRIEF DESCRIPTION OF THE DRAWINGS

FIG. 1 is a schematic drawing of meeting types of the present invention (An UML class diagram). As the diagram indicates, an abstract meeting type, Meeting, is formed. Project-Level Meeting is a sub type specialized from Meeting. There are seven sub-types of project level meetings;

FIG. 2 is a status diagram (i.e. state-chart diagram of UML) of meeting life cycle of the present invention;

FIG. 3 is a meeting process chart of the “support” job type of the present invention;

FIG. 4 is a context diagram of meeting process information system of the present invention, and

FIG. 5 is a schematic drawing of project development life cycle depicted by meeting process with the four job types and phases of the present invention.

### DETAILED DESCRIPTION OF THE INVENTION

The present invention is directed to an object-oriented meeting process model for software development management, which, via the help of analysis/design method of object-oriented system, depicts the meeting framework by defining meeting types, properties, state of objects and meeting behavior. And, it can present a description of the interaction of jobs or meetings and of how to deliver and handle the meeting document flow based on the meeting flow process of project management.

The present invention includes three parts as described below:

1. Definition of Meeting Operating Modes for Project Development

The definition of meeting operating modes required for project development comprises the following three elements:

(1) Defining Meeting's Abstract Data Type (ADT):

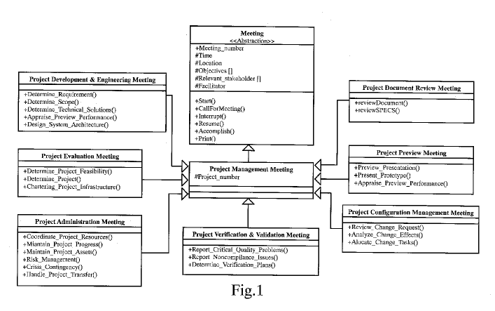

Firstly, to define the super-type of common meetings based on object-oriented technology. The common meetings refer to abstracted aggregation of meetings with similar properties. The present invention defines the operating modes according to the characteristics. FIG. 1 indicates the inheritance hierarchy of these meeting types.

(2) Modeling the States of the Meeting ADT:

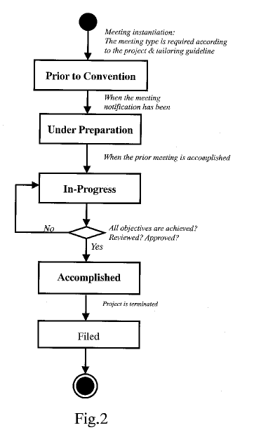

The present invention models the states of meeting life cycle as shown in FIG. 2. For example, the states of meetings are available with “prior to convention”, “under preparation”, “under progress”, or required repetitive “under progress” if meeting objectives are not met, and finally “accomplished” state. In addition to understanding of project progress, the quality of flow process can be further discussed through the states of meeting and time marks, rather than through sectional checkpoints.

For each state of meeting, the entry criteria and exit criteria shall be redefined. It is worthy to note that, a meeting shall be held again if scheduled objectives are not met. For smaller projects not yet completed, i.e. a meeting not yet completed due to some trivial issues, the meeting presider is entitled to designate some personnel for just review at his discretion. In such case, the meeting is still “under progress”. After completion of review of projects or documents, and submittal for approval by the meeting presider, the meeting is in a “accomplished” state. The documents shall be prepared and reviewed by personnel designated flexibly by the meeting presider during meeting preparation. The outputs of meeting shall be prepared and reviewed by personnel designated beforehand by the meeting presider during meeting preparation, or during the meeting.

(3) Modeling Meetings Happens During Project Development:

Besides, after identifying basic project hierarchy meeting type according to meeting interfaces, it is required to define seven common meeting types during software project development process and their associated meeting subtypes. These meeting types are derived from the properties and operation of project hierarchy meeting type, which also define relevant operations specific to individual meetings.

Seven common types include:

1. Project development and engineering meeting,

2. Project evaluation meeting,

3. Project administration meeting,

4. Project verification and validation meeting,

5. Project document review meeting,

6. Project preview meeting, and

7. Project configuration management meeting.

FIG. 1 depicts the definition of project meetings using UML class diagram in the present invention.

Based on the definition of seven common meeting types, the present invention further defines some subtypes, which not only conform to common meeting types, and are also well-suited for the feature of business, state of project teams, size and property of projects. In other words, it is possible to divide seven common meeting types in order to generate meeting subtypes satisfying the requirements of various jobs during project development. These meeting subtypes are useful to carefully select proper meeting types and meet individual project requirements according to the property of projects, namely solving the problem of project optimization. Finally, by using object-oriented aggregation concept based on features and requirements of meetings, these meeting subtypes are selectively aggregated into four software development jobs of present invention, i.e. first-phase preparation, development, service (maintenance) and support.

Thus, the present invention is intended to realize various software development objectives (including the outputs of documents and product mix) by using relevant meeting types of four aggregated jobs and meeting flow process.

2. Project Development Process Model Identified by Meetings

Project Development Process Represented by Job Types:

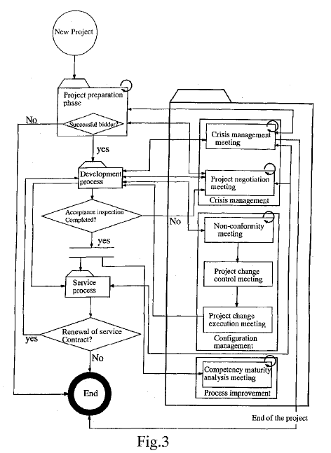

The following paragraph describes four job types of present invention involving software development process, common procedures and flow process of meetings as well as relationship of jobs. Take support jobs, for example, it depicts how to deliver necessary support to project preparation, development and service during meetings, as shown in FIG. 3. During the project planning phase, i.e. project preparation phase, the support jobs give assistance to the subject meetings such as resource allocation and crisis management (a type of Project Administration Meeting, see FIG. 1). If a project is not accepted during development process, support jobs are required to resolve this problem. After completion of acceptance check, this project enters into a parallel processing state (i.e. support job) to hold meetings for project review and process improvement. At the same time, the project enters into service phase for delivery and maintenance as well as product guarantee services. In the case of excess of guarantee time, it is required to discuss about renewing the contract, otherwise terminate the project cycle. If the contract is renewed, guarantee services shall be maintained. In addition to the meetings for solving aforesaid problems and crisis management, the support jobs include other combined subject meetings, such as configuration management, monitoring of project risk/budget/timing and quality assurance.

Meeting-Guided Project Development Documentation Process (i.e. Important Project Document Outputs)

This paragraph presents a description of data input and output of every job during meetings. A priority of discussion is placed on document flow in the present invention. The following is a concept of meeting-guided project development information system, with its Level 0 and Level 1 data and document flow charts described below:

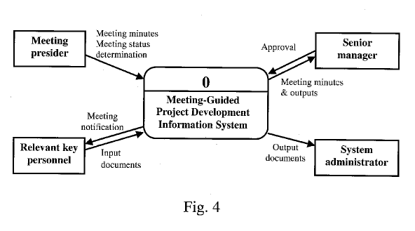

(1) Meeting-Guided Project Development Information System (DFD Level 0). Level 0 data flow diagram is shown in FIG. 4. While focusing on meeting-guided project development information system in an overall environment, the system administrator, senior manager, project meeting presider and relevant key personnel interact with this system for data input and output. The following paragraphs list the contents of data and document flow during interaction between individuals and system:

Project meeting presider: liable for convening meetings, recording the contents and entering the minutes into the information system after meetings, and then submitting for signature and approval by senior manager. If not approved, the minutes are fed back to project meeting presider, and then submitted for approval again after processing. The meeting presider is a user of this system during meetings.

Relevant key personnel: liable for entry of key project documents, e.g. loading to the system memory for future amendment and reference.

Senior manager: liable for reviewing and approving the minutes, and sending the results to the project meeting presider. With a function of flow process management, this system will automatically call once the meeting presider announces the conclusion of meeting, for example: automatically notifying the approver via email. In the course of various flow processes, the timer of this system can make your aware of the progress, for instance: recording the time interval from sending email to approval.

System administrator: liable for checking the output of project meetings and filing work (also including system maintenance).

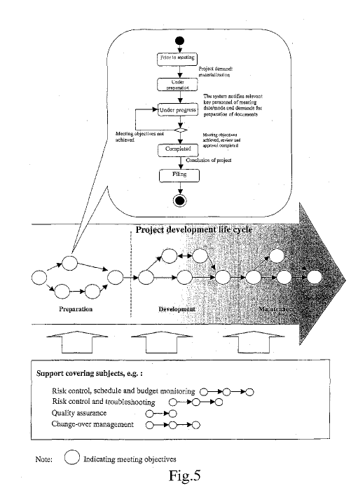

(2) Meeting-Guided Project Development Information System (DFD Level 1). The above-specified summarize the contents of data flow during interaction between individuals and system, whereas the following paragraph will give a detailed description of input and output of data flow during interaction between individuals and system. As shown in FIG. 5 for project management meeting process concept and FIG. 4 (information system of this concept), Level 1 data flow diagram divides meeting-guided project development information system into: 1.0: first-phase preparation; 2.0: development; 3.0: service; 4.0: support. The contents of document flow during interaction between individuals and system are described below:

Project meeting presider: liable for sending the minutes for project preparation, development, service and support, and also submitting to senior manager for examination and approval. Then, the system will send out approved information. After relevant jobs are completed, the project meeting presider is kept informed of conditions to process the minutes continuously. If approved, the minutes are deemed as outputs of project process, and then documented into database of the enterprise.

Relevant key personnel: liable for providing key documents related to the project as per requirements of the meeting. These documents are deemed as outputs of project process, and then documented into database of the enterprise for future reference.

Senior manager: liable for reviewing and approving the minutes of various jobs. If approved, the information of minutes is notified to the project meeting presider. In addition, the minutes shall be deemed as output of project process and documented into database. If not approved, the information still be notified to the project meeting presider for reprocessing.

System administrator: liable for checking the output of project process and filing in the database.

3. Project Meeting Process Optimization—Meeting Process Optimization Principle

Based on defined common meeting process as mentioned above, the present invention endeavors to design a process optimization principle for an optimum project. That's to say, when project optimization is required, incorporate the meeting of specific process. Thus, for each meeting to be held during the process, it is required to establish a meeting combination principle specific to meeting types, with its aim of achieving project optimization. The following examples demonstrate some basic meeting process optimization principles:

During meeting process, the meeting combination is divided depending upon job types, namely, among preparation, development and service types, at least one meeting shall be held, indicating that the process of specific job is concluded.

During meeting process, the meeting combination must follow the principle that the meetings are linked to each other for incorporation purpose, namely, the meeting objects to be incorporated must be linked to each other.

During meeting combination based on process priority, the meeting of top priority is selected to represent all meetings to be incorporated. Then, hold and mark the combined meeting.

As shown in FIG. 5 depicting the examples of basic meeting process optimization principle of the present invention, when the meeting process is to be optimized, all meetings for preparation, development and service (excluding support and process improvement) are incorporated at one's discretion for project optimization according to the classified job types.

For the operating mode of meetings, the inventor believes that it is free from geographical restriction. In the case of any geographical restriction, the meeting process management information system of present invention empowers the meeting presider to acts as a single user during meeting. Therefore, the meeting can be held at different sites via networking (e.g. Internet, on-line telephone, mobile phone or traditional dual-direction telephone). For example, teleconference is made possible via the help of other existing on-line conference devices, such as Net Meeting, or interaction tools such as MSN, ICQ, or virtual meeting room. Prior to the meeting, the meeting presider shall confirm prepared meeting documents and outputs via this system, and notify relevant key personnel by means of automatic e-mailing, while activating the life cycle of meeting (start-up of “meeting preparation”).

In brief, the aforementioned involve an innovative invention that can promote overall economic efficiency thanks to its many functions and actual value. And, no similar products or equivalent are applied in this technical field, so it would be appreciated that the present invention is granted patent as it meets the patent-pending requirements.

What is claimed is:

1. An object-oriented meeting process model for software development management, comprising:
defining a meeting framework by defining meeting types, properties, state of objects and meeting behavior via analysis/design method of object-oriented system, the meeting framework providing a description of interaction of jobs or meetings and of how to deliver and handle meeting document flow based on meeting process of project management.

2. The model as defined in claim 1, wherein the meeting process model improves the transparency of project management and strengthens information combination for an integrated project development.

3. The model as defined in claim 1, wherein common teleconference technologies are incorporated into actual meetings against geographical constraints.

4. The model as defined in claim 1, wherein another meeting is not convened when smaller projects have not yet been completed, the meeting is still “under progress” and the meeting results are submitted for examination and approval prior to turning the meeting into “accomplished” to prevent hasty conclusion of meetings.

5. The model as defined in claim 1, wherein drafters and authorities access and modify for modeling the relations between documents and relevant key personnel during definition of meetings, a meeting object occurs and the meeting is “under preparation” when convener is ready to hold a meeting, the system provides a display for real-time modification of access authority of key personnel.

6. The model as defined in claim 1, wherein the meetings are held based on general flow process and establish a flow optimization principle for project optimization purpose by means of meeting combination.
